(19) United States
(12) Patent Application Publication
(10) Pub. No.: US 2026/0112818 A1
(43) Pub. Date: Apr. 23, 2026

(54) PHASED ARRAY ANTENNA WITH IMPROVED MOUNTING

(71) Applicant: The MITRE Corporation, McLean, VA (US)

(72) Inventors: Matthew Anthony RYDER, Chelmsford, MA (US); John Paul LISTON, Wilmington, MA (US); Mohamed Wajih ELSALLAL, Acton, MA (US)

(73) Assignee: The MITRE Corporation, McLean, VA (US)

(21) Appl. No.: 19/360,617

(22) Filed: Oct. 16, 2025

Related U.S. Application Data
(60) Provisional application No. 63/709,333, filed on Oct. 18, 2024.

(51) Int. Cl. H01Q 21/00

(52) U.S. Cl. CPC H01Q 21/0087

(57) ABSTRACT

A phased array antenna is provided. The phased array antenna comprises a base plate comprising an opening and a plurality of projections disposed around the opening and extending below a bottom plane of the base plate. The phased array antenna further comprises a signal member extending outwardly from a top plane of the base plate, the signal member comprising a pin that is at least partially disposed within the opening and extends below the bottom plane. The pin and at least one of the plurality of projections are configured for connection to a printed circuit board (PCB).

### CROSS-REFERENCE TO RELATED APPLICATIONS

This application claims the benefit of U.S. Provisional Application No. 63/709,333, filed Oct. 18, 2024, the entire contents of which is incorporated herein by reference.

### STATEMENT OF FEDERALLY SPONSORED RESEARCH OR DEVELOPMENT

This invention was made with government support under FA8702-23-C-0001 awarded by the United States Air Force. The government has certain rights in the invention.

### FIELD

The present disclosure relates generally to phased array antennas, and more specifically to mounting configurations of phased array antennas.

### BACKGROUND

Phased array antennas have a wide range of application due to their ability to quickly and precisely steer and otherwise manipulate radiofrequency (RF) beams. Such applications may include military and meteorological radar, 5G wireless and satellite communication, and medical imaging. High frequency phased array antennas may be particularly useful for high-speed data transmission such as millimeter-wave communication and high-resolution imaging. However, as the operational frequency of the phased array antennas increases, and antenna envelopes become correspondingly smaller, connection of the array to RF front-end circuity driving each antenna may become increasingly challenging. Pins of signal members of high-frequency antennas may be less than 1.5 mm in width making connection using standard RF connectors infeasible.

### SUMMARY

Accordingly, disclosed herein are phased array antennas with improved mounting features and manufacturing methods. Small phased array antennas configured to operate at a frequency that is at least 18 GHz may be additively manufactured and may include a base plate at ground potential and a signal member forming an antenna to which a high-frequency RF excitation potential may be applied. The base plate may include an opening in which a pin of the signal member may be at least partially disposed and a bottom plane which the pin of the signal member may extend below. The excitation signal may be applied to the pin of the signal member while the RF beam emitting portion of the signal member may extend outwardly from a top plane of the base plate. The base plate may further include a plurality of projections that may be disposed around the opening and may extend below the bottom plane, with the pin of the signal member and at least one of the plurality of projections configured to be connected to a printed circuit board (PCB).

With connection surfaces such as those of the signal member pin and the plurality of projections extending below the bottom plane of the base plate, antennas disclosed herein may reduce the risk of electrical shorts being generated as a result of soldering an antenna to a PCB. Solder elements such as solder paste and/or solder balls, for example forming a ball grid array (BGA), may interface to the pin of the signal member and to at least one of the plurality of projections. With the solder contacting only on the bottom surface of the pin and at least one of the plurality of projections, the path length the solder must travel during the heating or reflow process to make a connection between grounded and non-grounded surfaces may be increased, thereby reducing the risk of electrical shorts.

In addition to extending the connection surfaces below the bottom plane of the base plate, solder connections grounding the antenna may be made at projections further from the signal member pin, thereby further increasing the path length along which solder would need to flow or migrate when heated to produce an electrical short. Additionally or alternatively, a thicker amount of solder paste may be used in place of a combination of solder paste and solder balls which may further mitigate solder migration resulting from the more precise manner in which solder paste may be applied and/or the material properties of the flux itself. Additionally or alternatively, a dielectric material may be placed within the opening surrounding the signal member pin to prevent solder material wicking into the opening thereby producing an electrical short between the signal pin which may be exposed to an excitation potential and the grounded base plate.

Phased array antennas disclosed herein may be manufactured using one or more additive manufacturing techniques and may include an exterior material with sufficient solderability. Additionally, to form the plurality of projections that may extend below the bottom plane of the antenna, one or more electrical discharge machining (EDM) processes may be used. This may result in one or more of the projections being configured for soldering to the PCB as discussed above and/or one or more projections not being configured for soldering to the PCB. Projections not configured for soldering to the PCB may rest on a PCB surface thereby reducing pressure on projections and other solder joints attaching the antenna to the PCB.

In some embodiments, a phased array antenna is provided, the phased array antenna comprising a base plate comprising an opening and a plurality of projections disposed around the opening and extending below a bottom plane of the base plate; and a signal member extending outwardly from a top plane of the base plate, the signal member comprising a pin that is at least partially disposed within the opening and extends below the bottom plane; wherein the pin and at least one of the plurality of projections are configured for connection to a printed circuit board (PCB).

In some embodiments, the pin and the at least one of the plurality of projections are configured for soldering to the PCB. In some embodiments, the pin and the at least one of the plurality of projections are soldered to the PCB using solder paste. In some embodiments, the pin and the at least one of the plurality of projections are soldered to the PCB using one or more solder balls. In some embodiments, the one or more solder balls form a ball grid array. In some embodiments, at least one of the plurality of projections is not configured for soldering to the PCB; and a shortest distance between the pin and the at least one of the plurality of projections configured for soldering to the PCB is longer than a shortest distance between the pin and the at least one of the plurality of projections not configured for soldering to the PCB. In some embodiments, the at least one of the plurality of projections not configured for soldering to the PCB is configured to contact the PCB. In some embodiments, at least one of the plurality of projections form a square cross-sectional shape, a rectangular cross-sectional shape, or a circular cross-sectional shape. In some embodiments, the pin extends through at least one of an airgap or a dielectric material disposed within the opening. In some embodiments, the signal member is a first signal member and the phased array antenna further comprises a second signal member attached to the base plate and proximate to the first signal member. In some embodiments, the phased array antenna further comprises a ground member attached to the base plate and proximate to the signal member. In some embodiments, a width of the pin of the signal member is no more than 1.5 mm; an impedance of the signal member is between 45 and 55 ohms; and the phased array antenna is configured to operate at a frequency of at least 18 GHz.

In some embodiments, a phased array antenna is provided, the phased array antenna comprising a base plate comprising an opening; and a signal member extending outwardly from a top plane of the base plate, the signal member comprising a pin that is at least partially disposed within the opening; wherein the pin extends through a dielectric material disposed within the opening and is configured for connection to a PCB.

In some embodiments, the signal member is a first signal member and the phased array antenna further comprises a second signal member attached to the base plate and proximate to the first signal member. In some embodiments, the phased array antenna further comprises a ground member attached to the base plate and proximate to the signal member. In some embodiments, a width of the pin of the signal member is no more than 1.5 mm; an impedance of the signal member is between 45 and 55 ohms; and the phased array antenna is configured to operate at a frequency of at least 18 GHz.

In some embodiments, a method of making a phased array antenna is provided, the method comprising forming, using at least one additive manufacturing technique, a base plate and a signal member, wherein a pin of the signal member is at least partially disposed within an opening in the base plate; and forming a plurality of projections around the opening using an electrical discharge machining (EDM) process; wherein the pin and the plurality of projections extend beyond a bottom plane of the base plate.

In some embodiments, the method further comprises forming, using the at least one additive manufacturing technique, a ground member proximate to the signal member. In some embodiments, the at least one additive manufacturing technique is at least one of a powder bed fusion process, a micro-stereolithography process, or a material jetting process. In some embodiments, the EDM process comprises at least one of a wire EDM process or a die-sinking EDM process.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts a cross-sectional view of an exemplary phased array antenna portion and a PCB, according to some embodiments.

FIG. 1B depicts a cross-sectional view of an exemplary phased array antenna portion and a PCB including a ground member, according to some embodiments.

FIG. 2 depicts a bottom view of a base plate and signal member pins of an exemplary phased array antenna portion, according to some embodiments.

FIG. 3 depicts a cross-sectional view of an exemplary phased array antenna portion connected to a PCB using a soldering process, according to some embodiments.

FIG. 4 depicts a bottom view of regions of an exemplary phased array antenna, according to some embodiments.

FIG. 5A depicts a plan view of a dual-polarized phased array antenna, according to some embodiments.

FIG. 5B depicts a unit cell of a dual-polarized phased array antenna, according to some embodiments.

### DETAILED DESCRIPTION

Disclosed herein are high-frequency phased array antennas with improved mounting techniques and associated manufacturing methods. To produce high-frequency RF signals, signal and/or ground members of antennas may be significantly smaller than lower-frequency antennas. For example, signal member pins of such high-frequency antennas may be less than 1.5 mm in width. Forming an electrical connection to such small pins may form a challenge due to the size of the pin. Instead of using standard electrical connectors, high-frequency antennas may be mounted onto PCBs using one or more soldering techniques.

Soldering small electrical components to a PCB may commonly be accomplished using a plurality of solder balls, for example forming a BGA.

Attachment of a high-frequency antenna to a PCB using a BGA process may involve adding one or more small solder balls to the PCB, placing the antenna on top of the PCB, and controllably melting or reflowing the solder balls to create an electrical and/or mechanical connection. However, when the bottom surface of the antenna and/or the top surface of the PCB are not flat, for example due to manufacturing defects, solder can migrate asymmetrically and/or wick into gaps between signal member pins. This issue may be exacerbated by lack of precise control of solder ball size and placement locations, and by any misalignment between an antenna and the PCB onto which is mounted. This non-planarity may result in solder that migrates asymmetrically and by distances sufficient to create significant risks of electrical shorts developing during operation of the antenna.

Phased array antennas disclosed herein may include one or more features designed to enable antenna-PCB mounting without the shortcomings described above. For example, antennas disclosed herein may include signal members including a pin that may be at least partially disposed in an opening of a base plate of the antenna and extend beyond a bottom plane of the antenna, thereby creating an elevation gap between the connection surface of the pin and the bottom plane of the antenna. Similarly, exemplary phased array antennas may include a plurality of projections extending below the bottom plane of the antenna such that the connection surface of projections configured for soldering to the PCB may be disposed at a vertical distance from the bottom plane of the antenna. Additionally, projections configured for soldering to the PCB may be selected based on distance from the signal member pin such that a distance between the pin and said projections is maximized. Thus, disclosed antennas may include features that increase the horizontal and vertical distance, for example the surface path length between surfaces at ground potential and surfaces exposed to an excitation potential that may drive signal members of the antenna. This increased path length may thus reduce the likelihood that any migration of the solder during a heating or reflowing stage may result in the solder bridging between a grounded and non-grounded surface thereby producing a short.

To further reduce the risk of shorts and/or unreliable solder connections forming, antennas disclosed herein may use solder paste instead of solder balls given that the more precise means by which solder paste may be applied may prevent over-application of solder and otherwise reduce the degree to which solder may migrate. Additionally or alternatively, the opening through which the signal member pin passes, instead of being formed of air, may be filled with a dielectric material. Addition of dielectric material to this space may significantly reduce the likelihood that solder may wick into this opening thereby producing a short between the signal member surface and the ground plate surface.

Phased array antennas disclosed herein may include one or more types of antenna configurations. In some implementations, single signal member antennas may be included with features as described above. In other implementations, a signal member may be paired with a ground member, for example attached to the grounded base plate of the antenna to form a dipole antenna. In other implementations, a signal member may be paired with another signal member to form a differential antenna. Phases between two signal members in a differential antenna and between various types and/or sets of antennas making up a phased array antenna may be controlled for example to enable steering and/or directing of the resulting RF signal.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

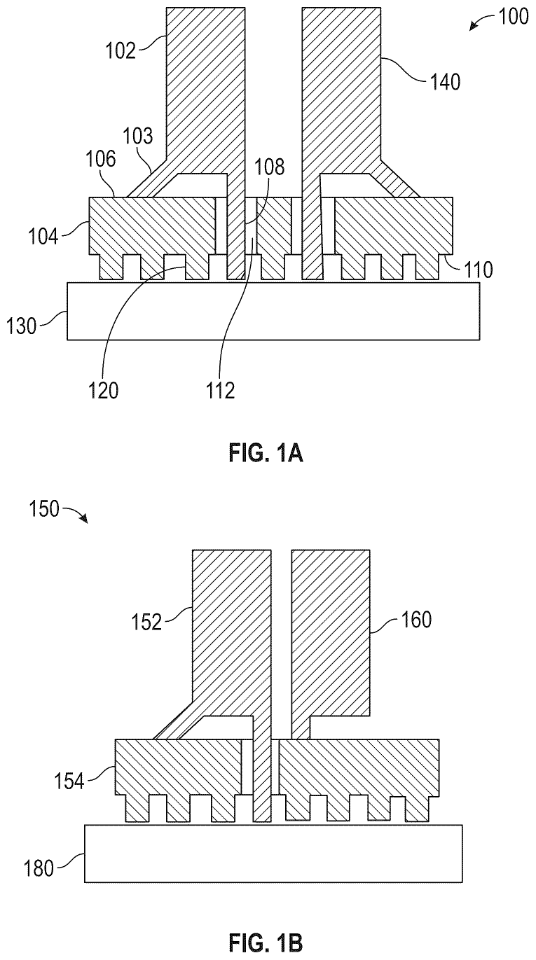

FIG. 1A depicts a cross-sectional view of a portion of a phased array antenna 100, including a signal member 102 and a base plate 104, mounted on top of a PCB 130. The phased array antenna may be made at least partially of a conductive material to enable generation of RF signals when connected to an excitation potential. For example, the phased array antenna may be made of a metallic material that may be soldered readily, for example copper, silver, and/or gold. Alternatively or additionally the antenna may be made of a different metallic material, such as aluminum, a plastic material, and/or a ceramic material that is then plated, for example by electroplating, with one a suitable metallic material to enable solderability. The phased array antenna may be machined and/or may be additively manufactured out of one or more materials. Additive manufacturing techniques may include a powder bed fusion process such as laser powder bed fusion, direct metal laser sintering, and/or electron beam additive manufacturing; a micro-stereolithography process such as vat photopolymerization using metal powder; and/or a material jetting process such as nanoparticle jetting and/or inkjet printing. Signal member 102 and base plate 104 may be formed of the same material and may be manufactured to form the same component, for example each may be machined out of the same piece of material and/or formed in the same additive manufacturing process step, for example one or more of the additive manufacturing processes discussed above.

Signal member 102 may be connected to base plate 104 via a connecting portion 103. Signal member 102 may include an upper portion extending outwardly from a top plane 106, and a pin 108 at least partially disposed within an opening 112 in base plate 104 and extending below a bottom plane 110. Pin 108 may be connected to a portion of PCB 130, for example a conductive pad, via a soldering technique as described in greater detail below. PCB 130 may be used to supply a high-frequency RF excitation potential to signal member 102 via pin 108, thereby enabling the upper portion extending above top plane 106 to generate an RF signal. Base plate 104 may be at ground potential, such that opening 112 may provide electrical isolation between the grounded walls of base plate 104 and pin 108 which may be exposed to an excitation potential. As described in further detail below, base plate 104 may include a plurality of projections such as projection 120 that may extend below bottom plane 110 optionally by a similar distance to the distance by which pin 108 extends below bottom plane 110. In this way, the plurality of projections may be formed the same component and be formed of the same material as the remainder of antenna portion 100 including base plate 104. One or more of these projections may be connected to a conductive portion of PCB 130, for example a conductive pad, via a soldering technique as described below.

As depicted in FIG. 1A, signal member 102 may be used in conjunction with, for example, a second signal member 140 that may include an upper portion of similar geometry to and/or facing an opposite direction from the upper portion of signal member 102. As shown, second signal member 102 may include a pin similar to pin 108 passing through an opening in base plate 104 similar to opening 112 and may connect to PCB 130 using a similar soldering technique. In this way, the two signal members may form a differential antenna, for example with the excitation potential applied to one signal member the opposite in phase to the excitation potential applied to the other signal member. To enable steering and/or directing of RF signals generated by the array, an exemplary phase array antenna may include one or more such members, for example one or more signal members, one or more sets of signal and ground members, and/or one or more sets of two signal members. For example, by varying the phases of excitation potentials applied to each member and/or set of members, the direction of constructive interference, and thus the direction of the resulting RF beam may be controlled. Such differential antennas may be advantageous over dipole antennas given their ability to suppress common mode noise that may arise in certain operational environments.

As depicted in the cross-sectional view of FIG. 1B, phased array antenna portion 150 may include a signal member 152 to be used in conjunction with, for example, a ground member 160 with an upper portion that, like second signal member 140, may be of similar geometry to and/or facing an opposite direction from the upper portion of signal member 152. Instead of including a pin, ground member 160 may be directly attached to base plate 154 and/or signal member 152 and may thus be at ground potential without exposure to an excitation potential from the PCB. For example, ground member 160 may be formed of the same material as base plate 154 and/or signal member 152 and may be manufactured to form the same component as base plate 154 and/or signal member 152. For example, each of ground member 160, base plate 154, and/or signal member 152 may be machined out of the same piece of material and/or formed in the same additive manufacturing process step, for example one or more of the additive manufacturing processes discussed above. Ground member 160 may thus work in concert with signal member 152 to generate and direct an RF beam, for example by forming a dipole antenna.

In this way, one or more of the members of a differential antenna and/or dipole antenna may form a folded, unipole, single-layer, elliptical (FUSE) antenna member taking advantage of the wide operational frequency range and compact design associate with FUSE antennas.

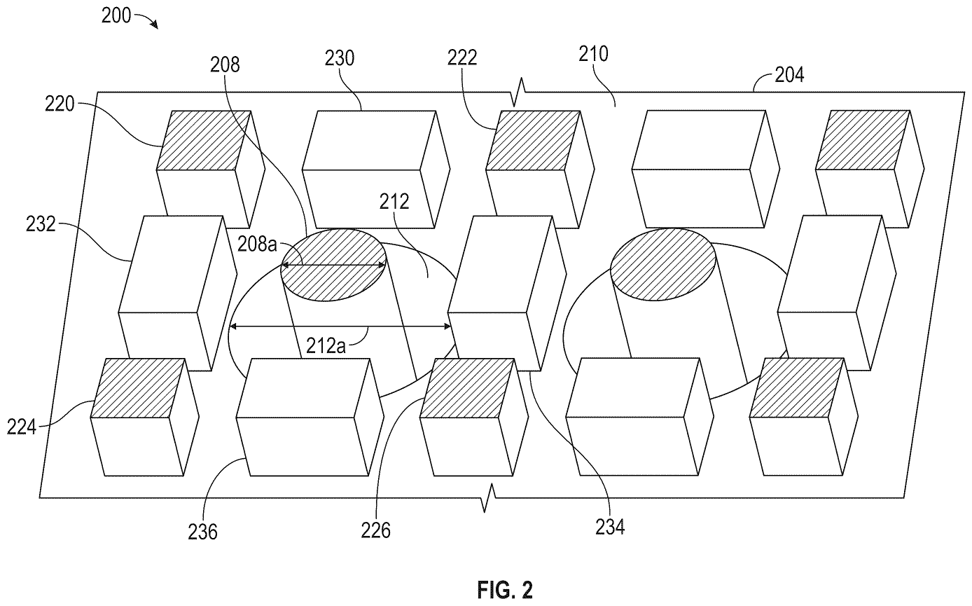

FIG. 2 depicts a bottom view of a phased array antenna portion 200 including base plate 204, pins of signal members including pin 208, and a plurality of projections including projection 220. In this view, the exposed surfaces of, for example, pin 208 and projection 220, are configured to connect to a PCB such as PCB 130 of FIGS. 1A and 1B. Thus, these exposed surfaces that extend below bottom plane 210 of base plate 204, when combined with a PCB assembly, may be facing downward to enable the antenna to be mounted atop the PCB. In this way, because FIG. 2 represents a bottom view, features that may extend below the bottom plane may appear in the FIG. 2 to be vertically higher than the bottom plane.

As mentioned above, pin 208 of an associated signal member may be at least partially disposed within opening 212 of base plate 204. Base plate 204 may be at ground potential while pin 208 of the signal member may be exposed to an excitation potential applied via circuitry on the PCB. In high-frequency phased array antennas, for example antennas operating at a frequency that is at least 18 GHz, ensuring an impedance match between an RF source and one or more signal members of the phased array antenna may be particularly important to ensure power transfer is maximized and reflections that may degrade signal quality are minimized. To ensure sufficient power transfer with minimal signal loss, each signal member and/or ground member of an RF system may have a target impedance of between 45 and 55 ohms and/or approximately 50 ohms. At high frequencies, even small deviations from a target impedance value may result in reductions in efficiencies and distortions in the direction of a resulting RF signal.

Thus, the material present within, for example, opening 212 between pin 208 and base plate 204, and the ratio between width 208a of pin 208 and width 212a of opening 212 may be an important factor in producing a 45-55 ohm and/or approximately 50-ohm impedance at signal member pin 208 and maximizing power transfer and minimizing reflections that may occur when impedances within the RF circuit are mismatched. For example, width 208a may be less than 1.5 mm, less than 1 mm, less than 0.5 mm, less than 0.3 mm, and/or less than 0.1 mm. Opening 212 may be left unfilled, allowing air to form the dielectric gap between pin 208 and base plate 204. Opening 212 may additionally or alternatively be filled with a dielectric material such as polytetrafluoroethylene (PTFE) and/or alumina. Because the impedance of opening 212 may be a function of the relative permittivity of the dielectric material placed within it, differing relative permittivity values between air and a selected dielectric material may result in shifts in the impedance value of the phased array antenna. To address these shifts, the ratio between widths 208a and 212a may be adjusted to maintain an impedance at signal member pin 208 that is between 45 and 55 ohms and/or approximately 50 ohms.

With a target impedance of approximately 50 ohms at each member of the phased array antenna, for example at each signal member and/or each ground member, antenna portions including more than one member, for example dipole and/or differential antenna portions, may have a higher impedance target. That is, an antenna portion including two members may have a target impedance value that is approximately twice that of an antenna portion including one member. Thus, an antenna portion including two members, for example a dipole and/or a differential antenna portion, may have a target impedance of between 90 and 110 ohms and/or approximately 100 ohms.

As discussed above, pins of signal members including pin 208 and/or a plurality of projections including projection 220 may extend below bottom plane 210. These pins and/or projections may be generated in one or more manufacturing steps. For example, if base plate 204 is formed out of a metallic material, one or more wire EDM cuts may be made in two directions that may be orthogonal to one another to create the plurality of projections and/or pins shown in FIG. 2. For example, these two orthogonal cuts may form two square waves on orthogonal planes normal to the base of the antenna. Additionally or alternatively, the plurality of projections, pins, and/or openings may be formed using a die-sinking or sinker EDM process. For example, a die that matches the desired pin, projection, and/or opening pattern may be formed and used to create the pins, projections, and/or openings shown in FIG. 2. Additionally or alternatively, cuts similar to those that may be made by a wire EDM may instead be made by a slitting saw, with the advantage that the slitting saw may function with wider range of antenna materials.

As a result of this process, the plurality of projections formed may be disposed around one or more openings through which a pin of a signal member may be at least partially disposed. For example, as depicted in FIG. 2, the plurality of projections may include projections 220, 222, 224, and/or 226 that may be disposed at approximately 0, 90, 180, and/or 270 degrees about pin 208. In this case, each of projections 220, 222, 224, and/or 226 may be positioned at a corner of an imaginary shape approximately forming a square, with pin 208 located at the center of the approximate square. The plurality of projections may additionally include projections 230, 232, 234, and/or 236 that may be disposed at approximately 45, 135, 225, and/or 315 degrees about pin 208. In this case, each of projections 230, 232, 234, and/or 236 may be positioned at the center of an edge of an imaginary shape approximately forming a square, with pin 208 located at the center of the approximate square. Based on the width 208a of pin 208 and/or width 212a of opening 212, one or more of the plurality of projections may include a downward-facing square cross-section, a downward-facing rectangular cross-section, and/or a downward-facing circular cross-section. For example, projections 230, 232, 234, and/or 236 may include a downward facing square cross-section, and/or projections 230, 232, 234, and/or 236 may include a downward facing rectangular cross-section.

To connect the phased array antenna to a PCB, one or more soldering techniques may be used. Such techniques may be used, for example, to connect pin 208 to a conductive pad on the PCB in turn connected to an RF circuit configured to apply an excitation potential to the conductive pad and pin 208. To connect pin 208 to a conductive pad of the PCB, a solder element may be applied to the particular conductive pad of the PCB pin 208 may be configured to connect to. For example, this solder element may take the form of a solder paste. The application of solder paste may be accomplished using a laser-cut PCB stencil such as a surface mount technology (SMT) stencil. Such a stencil may control the thickness of the applied solder paste via the thickness of the stencil and/or the positioning of the solder paste to ensure application only to a designated portion of the PCB, for example one or more designated conductive pads. Alternatively or additionally, this solder element may take the form of a solder ball, for example placed directly onto a portion of the PCB and/or applied following application of solder paste to the portion of the PCB. Such a solder ball may form part of a solder ball grid array (BGA) approach in which a plurality of points on an antenna, for example a plurality of pins and/or projections are electrically and/or mechanically attached to portions of a PCB. To use one or more solder balls in such a manner, the solder balls may be attached to the PCB, placed directly onto a PCB and/or placed onto the PCB following application of the solder paste, for example using a solder ball placement machine or mounter. Once the solder balls have been applied, the PCB may be heated to reflow the solder balls and generate the electrical and/or mechanical connection. For example, the PCB may be placed in a reflow oven to generate heat sufficient to reflow the solder balls. In implementations in which only solder paste is applied, the thickness of solder paste may be increased, optionally by increasing the thickness of the stencil used to apply the paste, to ensure sufficient solder material is available to create an electrical and/or mechanical connection.

In addition to pin 208, one or more of the plurality of projections of base plate 204 may be connected to the PCB using the one or more of the soldering techniques described above. These one or more projections may be connected to conductive pads of the PCB that may be at ground potential, for example establishing an electrical and/or mechanical connection between base plate 204 and the PCB. These one or more soldering techniques may include, for example, application of solder paste, application of one or more solder balls, and/or application of one or more solder balls following application of solder paster. By attaching the one or more projections using the one or more soldering techniques, the antenna may be securely mounted to the PCB and/or the base plate 204 may be electrically well-grounded. Such grounding may be advantageous in, for example, providing sufficient electromagnetic shielding and/or reducing interference from external noise sources. One or more of the plurality of projections may not be configured for soldering to PCB 130, for example projections 230, 232, 234, and/or 236 may not be configured for soldering to the PCB instead optionally contacting the PCB and/or reducing the contact pressure that may be present at surfaces of one or more other projections. This reduction in pressure may be useful, for example, during the reflow soldering process as discussed below. One or more of the plurality of projections may be configured for soldering to PCB 130, for example projections 220, 222, 224, and/or 226, including surfaces of these projections shown with a hatch pattern in FIG. 2. As discussed above, these projections may provide an electrically grounding and/or mechanical connection between the antenna and PCB.

In implementations in which solder paste may form the solder elements used to solder one or more projections to the PCT, projections not configured for soldering to PCB 130 may be masked and projections configured for soldering to PCB 130 and/or signal member pins may be left exposed using a laser-cut PCB stencil such as a SMT stencil as discussed above. The stencil may first be aligned over PCB 130, solder paste may be placed over the stencil, and a squeegee blade may be used to spread a uniform layer of solder paste over the surface of the stencil. In this way, solder paste may be applied to projections configured for soldering to PCB 130 and/or to signal member pins, and not to projections not configured for soldering to PCB 130.

According to known techniques, high-frequency phased array antennas may be manufactured without projections and/or pins of the signal members extending below the bottom surface of the antenna. Thus, when the antenna is mounted to the PCB assembly, for example by using a soldering technique such as BGA, the solder elements may contact the bottom plane of the base plate of the antenna and/or the bottom surface of the pins of signal members, which may be flush with the bottom plane. In this way, solder elements may be squeezed between the bottom plane of the base plate and/or bottom surface of the signal member pin on one hand and a portion of the PCB, for example one or more conductive pads, on the other hand. Such an approach may be sensitive to planarity issues that may arise during manufacturing and/or assembly of PCBs and antennas.

For example, a PCB may be warped due to poor temperature control during the manufacturing process and/or the bottom plane of the antenna may have deviations within manufacturing tolerances that reduce planarity. When the bottom plane of the antenna and/or the conductive pads of the PCB deviate from aligned planar surfaces, planarity or pancaking issues may arise in which the solder element, for example solder ball, may be squeezed in one direction more so than in a different direction, causing the solder to migrate to locations it may not be designed for. In some instances, solder may migrate to and wick into an opening between a signal member pin, which may be exposed to an excitation potential, and the grounded base plate, causing an electrical short. In other instances, solder that migrated elsewhere may not form the desired electrical and/or mechanical connection at the point the solder was placed at. This issue may be exacerbated by placement of solder balls of varying sizes, with solder balls that are larger than specified migrating further than intended, by misalignment between an antenna and the PCB onto which it is mounted, and/or by installing the antenna onto the PCB with too great a force, for example due to misconfiguration of the pick-and-place machine used during installation.

Phased array antennas disclosed herein may reduce the negative effects of such planarity issues in one or more ways. As discussed above and shown in FIG. 2, the plurality of projections and/or signal member pin 208 may project below bottom surface. By shifting the connection and/or soldering surface from a single, shared plane to a plurality of smaller, elevated surfaces, phased array antennas disclosed herein may create electrical and/or mechanical connections between small, high-frequency antennas despite the inherent deviations from planarity between antenna and PCB surfaces, and despite deviations in solder ball size, antenna-PCB alignment, and/or antenna installation force. That is, by interfacing to solder elements such as solder paste and/or solder balls on a PCB using smaller, elevated surfaces, solder may spread out laterally and/or pancake when the antenna is installed on the PCB however as it spreads out, it may also wick upward (e.g. downward in the bottom view of FIG. 2) toward bottom plane 204. This combined lateral and vertical motion may thus involve less lateral motion than techniques in which solder elements contact a single plane. Stated differently, with the plurality of projections and/or signal member pin 208 extended below bottom surface 204, the surface length of two paths may be increased: (1) the path from a point at which solder for a ground connection was installed (e.g. each projection configured for soldering) to a surface exposed to an excitation potential (e.g. signal member pin 208), and (2) the path from a point at which signal member pin solder was installed to a point on the antenna at ground potential. This increased surface path length in turn may reduce the likelihood that, during exposure to the heat of the reflow process, solder from a signal member pin and/or projection may wick into the opening surrounding the pin, thereby causing an electrical short.

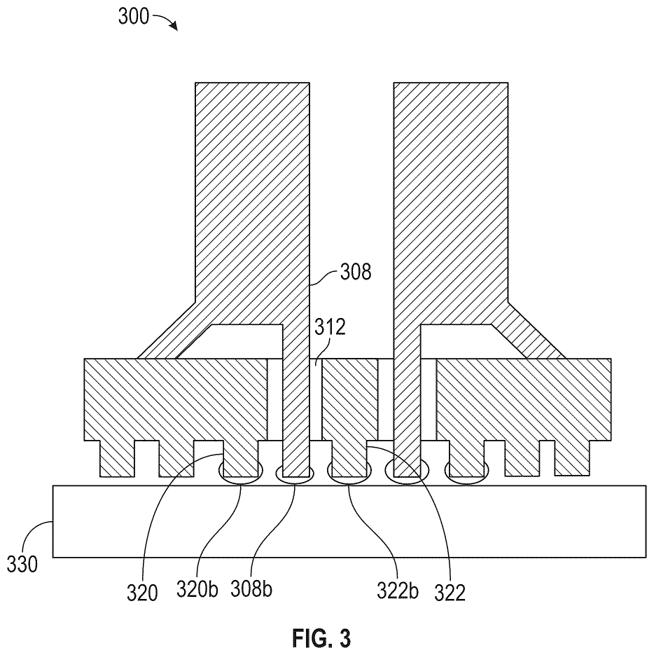

The effect of extending connection surfaces below the bottom surface of the base plate may be visualized with reference to FIG. 3 which depicts phased array antenna portion 300. In FIG. 3, solder elements, for example solder paste and/or solder balls, 320b, 308b, and 322b, may be placed on PCB 330 so as to align with projection 320, signal member pin 308, and projection 322, respectively. Following placement of the antenna onto PCB 330 and heating of the assembly, for example during a reflow process, the solder of solder elements 320b, 308b, and/or 322b may migrate laterally along the PCB, for example along the surface of one or more conductive pads of the PCB. The solder may also migrate vertically, up projection 320, signal member pin 308, and/or projection 322. However, each solder element may have a longer surface path length to migrate to reach a gap between a surface at ground potential and a surface exposed to an excitation potential as a result of extending projection 320, signal member pin 308, and/or projection 322 below bottom surface 310. For example, solder elements 320b and 322b now must migrate laterally along the bottom surface of projections 320 and 322 respectively before migrating up the vertical surfaces of the two projections before migrating laterally again to reach and potentially wick into opening 312. For example, solder element 308b now must migrate laterally along the bottom surface of signal member pin 308 before migrating up the vertical surface of the pin to reach and potentially wick into opening 312. Without extension below bottom surface 310, these solder elements may have been placed significantly closer to one another and to electrically insulating gaps surrounding signal member pins, making electrical shorts due to the planarity issues discussed above significantly more likely. While projections not configured for soldering to the PCB 330 such as those depicted in FIG. 3 without solder elements applied may in fact rest on the surface of PCB 330, for example on the PCB solder mask, and assist with distribution of antenna weight and/or maintenance of antenna alignment as discussed in further detail below.

Greater extension of connection surfaces may result in reduced antenna performance but reduced solder migration while lower extension of connection surfaces may result in increased antenna performance but increased solder migration. However, because solder migration may also be a function of lateral separation between, for example, signal member pins and projections configured for soldering to the PCB, there may be a range of extension heights and pin-projection distances that minimize antenna performance reductions while ensuring the likelihood of solder migration sufficient to cause electrical shorts is acceptably low.

In addition to extending connection surfaces below the bottom plane of the antenna, the selection of which of the one or more of the plurality of projections may be configured for soldering to the PCB may be made to further increase the surface path length between the signal member pin and each projection soldered to the PCB. As mentioned above, in some implementations, one or more of the plurality of projections may be configured for soldering to the PCB and/or one or more of the plurality of projections may not be configured for soldering to the PCB. Referring again to FIG. 2, projections 220, 222, 224, and/or 226 producing a ground potential connection to the PCB, may be selected to be configured for soldering to the PCB based on their location. As shown, the shortest distance between signal member pin 208 and projections 220, 222, 224, and/or 226 may be longer than the shortest distance between signal member pin 208 and projections 230, 232, 234, and/or 236. Thus, selecting projections to be configured for soldering the PCB that may maximize the lateral distance between said projections and the nearest opening surrounding a signal member pin, the surface path length for solder to migrate to reach such an opening may be increased. This increased path length may further reduce the risk that solder migration due to inherent planarity issues may generate an electrical short and/or otherwise disrupt antenna performance.

In addition to extending connection surfaces below the bottom plane of the antenna and selecting projections for ground potential connections that are further from the signal member pin than alternative projections, exemplary phased array antennas may be further configured to reduce shorting risk. For example, as discussed above, a dielectric material such as PTFE and/or alumina may be placed into opening 212 of base plate 204. By filling opening 212 with a material, the risk of solder from the connection of signal member pin 208 and/or a projection configured for soldering to the PCB, for example projections 220, 222, 224, and/or 226, wicking into opening 212 may be significantly reduced. Instead of wicking into the opening and/or creating an electrical short between signal member pin 208 exposed to an excitation potential and grounded base plate 204, the solder may be forced to migrate laterally across the top of the dielectric material placed into opening 212, thereby further increasing the path length traveled before causing antenna performance issues.

Finally, as discussed above, solder paste may be used in place of solder balls and/or BGA techniques. A thicker layer of solder paste may help make up for an absence of solder balls and may be created, for example, by using a thicker stencil mask as discussed. By using solder paste only, and not solder balls, solder migration during heating and/or reflowing of the solder may be reduced. This may be a result of the inclusion in solder paste of solder particles and flux, helping the solder paste adhere to the conductive pads of the PCB. The flux may also clean the conductive pads improving the contact between the solder and pads, further reducing migration. Additionally, solder paste may be applied using a high-precision PCB stencil as discussed, ensuring that the volume of solder paste applied the conductive pads of the PCB is precisely controlled, preventing the application of excess solder elements. Solder balls by contrast may flow more easily off a conductive pad and/or may present challenges in generating balls of a precise size and/or placing them at a precise location.

Each of the above-described solutions may be implemented in isolation or in combination with one another. For example, connection surfaces may be projected below the bottom surface of the base plate, projections for ground potential connections may be selected that are further from the signal member pin than alternative projections, and/or dielectric material may be added to the opening in the base plate between a signal member pin and the base plate. In this way, in some implementations, an antenna may not include any projections and/or signal member pins may not extend below the bottom plane of the base plate. To address planarity and electrical shorting issues in such implementations, dielectric material may be added to openings in the base plate surrounding signal member pins.

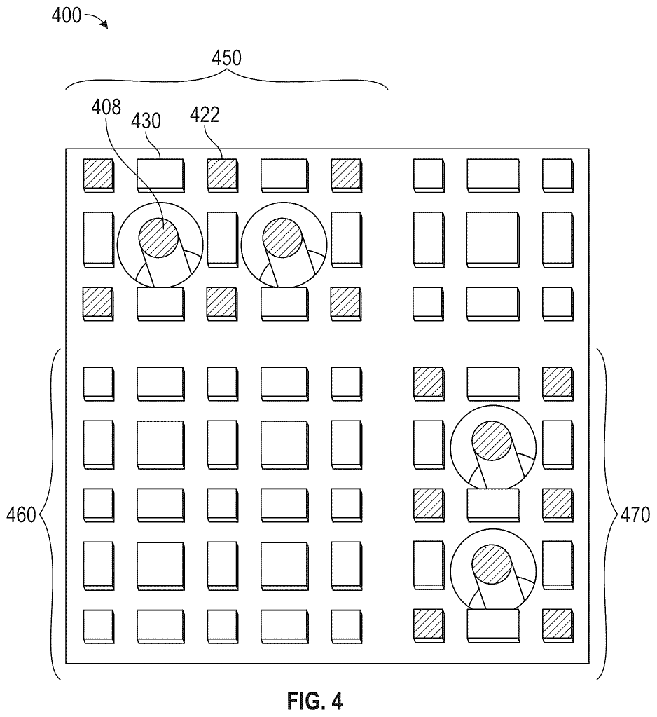

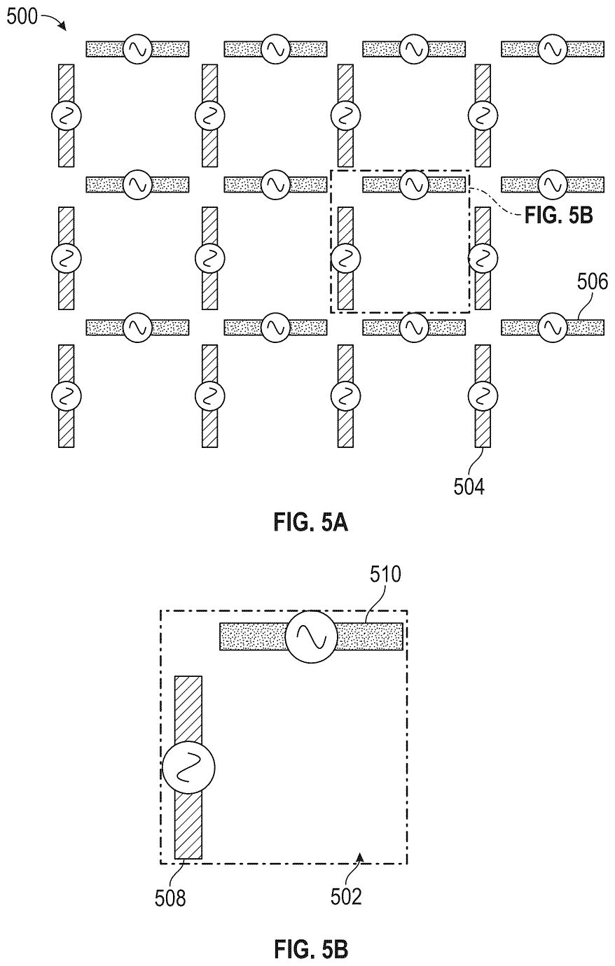

FIG. 4 depicts an exemplary phased array antenna portion 400 which may be comprised of a plurality of signal and/or ground members, and/or a plurality of projections. For example, an exemplary phased array antenna may include differential antenna portions 450 and 470, each with two signal member pins including signal member pin 408, one or more projections including projection 430 that are not configured for soldering to a PCB, and/or one or more projections including projection 422 and depicted with a hatch pattern that are configured for soldering to the PCB. Differential antenna portions 450 and 470 may repeat in a pattern comprising one or more rows and/or one or more columns, and may be oriented such that each antenna portion is oriented orthogonal to one or more other antenna portions as discussed below in the context of FIGS. 5A and 5B.

An exemplary phased array antenna may additionally include regions such as region 460 which may include projections that may not be configured for soldering to the PCB. Such projections and/or such regions may be formed as a result of one or more wire EDM processes used to create the plurality of projections given that the wire used in the wire EDM process may pass over the entirety of the base plate. Such projections and/or such regions despite not playing a role in grounding the antenna may nonetheless serve one or more functions that may reduce the effects of planarity issues discussed above. For example, such regions may rest on the solder mask or solder resist, for example a protective layer applied to the PCB, and support the weight of the antenna mounted on top of the PCB, thereby reducing the pressure on projections configured for soldering and/or reducing the misalignment of the projection and/or pin surfaces with contact surfaces of the PCB, for example one or more conductive pads. This reduced pressure and/or planar misalignment may respectively reduce the degree to which solder migrates and/or migrates in a non-uniform manner, in turn reducing the likelihood of electrical shorts and/or unreliable solder connections.

FIG. 5A depicts an exemplary antenna array of radiating elements 500. One or more of the radiating elements making up this array may be formed using any of the above-described mounting techniques and/or manufacturing methods. For example, one or more of the radiating elements discussed below may be similar in form to differential antenna portions 450 and/or 470 that each contain a portion of a phased array antenna. In FIG. 5A, a dual polarized configuration is shown with radiating elements oriented both horizontally 506 and vertically 504. In this embodiment, a unit cell 502 includes a single horizontally polarized radiating element 510 and a single vertically polarized radiating element 508 as shown in FIG. 5B. Array 500 is a 4×3 array of unit cells 502. In some implementations, array 500 may be scaled up or down to operate over a specified frequency range. More unit cells may be added to meet other specific design requirements such as antenna gain. In some implementations, modular arrays of a predefined size may be combined into a desired configuration to create an antenna array to meet the specified performance objective. For example, a module may include the 4×3 array of radiating elements 500 illustrated in FIG. 5A. A particular antenna application requiring 96 radiating elements can be built using eight modules fitted together thereby providing the 96 radiating elements. This modular design may thus allow for antenna arrays to be tailored to specific design requirements at a lower cost.

As shown in FIG. 5B, radiating element 508 is disposed along a first axis and element 510 is disposed along a second axis that is orthogonal to the first axis, such that element 508 is substantially orthogonal to element 510. This orthogonal orientation results in each unit cell 502 being able to generate orthogonally directed electric field polarizations. That is, by disposing one set of elements (e.g. vertical elements 504) in one polarization direction and disposing a second set of elements (e.g. horizontal elements 506) in the orthogonal polarization direction, an antenna which can generate signals having any polarization is provided. In this particular example, unit cells 502 are disposed in a regular pattern, which here corresponds to a square grid pattern. Those of ordinary skill in the art would appreciate that unit cells 502 need not all be disposed in a regular pattern. In some applications, it may be desirable or necessary to dispose unit cells 502 in such a way that radiating elements 508 and 510 of each unit cell 502 are not aligned between every unit cell 502. Thus, although shown as a square lattice of unit cells 502, it would be appreciated by those of ordinary skill in the art, that antenna 500 could include but is not limited to a rectangular or triangular lattice of unit cells 502 and that each of the unit cells can be rotated at different angles with respect to the lattice pattern.

The mounting and/or soldering techniques disclosed herein may not be limited to attachment of antennas to PCBs and may extend to attachment of chips and/or other electrical components to PCBs. For example, chips and/or other electrical components may include planar and/or pad-based connections in which solder connections formed based on known techniques may result in migration of solder, the formation of electrical shorts, and/or other issues that may degrade electrical performance. By including one or more of the mounting designs and/or manufacturing techniques disclosed herein, for example forming electrical connections on separate and/or raised surfaces, separating grounded and non-grounded surfaces, using solder paste instead of solder balls, and/or filling gaps with dielectric materials to reduce wicking, mounting of chips and/or electrical components may be improved.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A phased array antenna comprising:
a base plate comprising an opening and a plurality of projections disposed around the opening and extending below a bottom plane of the base plate; and
a signal member extending outwardly from a top plane of the base plate, the signal member comprising a pin that is at least partially disposed within the opening and extends below the bottom plane;
wherein the pin and at least one of the plurality of projections are configured for connection to a printed circuit board (PCB).

2. The phased array antenna of claim 1, wherein the pin and the at least one of the plurality of projections are configured for soldering to the PCB.

3. The phased array antenna of claim 2, wherein the pin and the at least one of the plurality of projections are soldered to the PCB using solder paste.

4. The phased array antenna of claim 2, wherein the pin and the at least one of the plurality of projections are soldered to the PCB using one or more solder balls.

5. The phased array antenna of claim 4, wherein the one or more solder balls form a ball grid array.

6. The phased array antenna of claim 2, wherein:
at least one of the plurality of projections is not configured for soldering to the PCB; and
a shortest distance between the pin and the at least one of the plurality of projections configured for soldering to the PCB is longer than a shortest distance between the pin and the at least one of the plurality of projections not configured for soldering to the PCB.

7. The phased array antenna of claim 6, wherein the at least one of the plurality of projections not configured for soldering to the PCB is configured to contact the PCB.

8. The phased array antenna of claim 1, wherein at least one of the plurality of projections form a square cross-sectional shape, a rectangular cross-sectional shape, or a circular cross-sectional shape.

9. The phased array antenna of claim 1, wherein the pin extends through at least one of an airgap or a dielectric material disposed within the opening.

10. The phased array antenna of claim 1, wherein the signal member is a first signal member and the phased array antenna further comprises a second signal member attached to the base plate and proximate to the first signal member.

11. The phased array antenna of claim 1, wherein the phased array antenna further comprises a ground member attached to the base plate and proximate to the signal member.

12. The phased array antenna of claim 1, wherein:
a width of the pin of the signal member is no more than 1.5 mm;
an impedance of the signal member is between 45 and 55 ohms; and
the phased array antenna is configured to operate at a frequency of at least 18 GHz.

13. A phased array antenna comprising:
a base plate comprising an opening; and
a signal member extending outwardly from a top plane of the base plate, the signal member comprising a pin that is at least partially disposed within the opening;
wherein the pin extends through a dielectric material disposed within the opening and is configured for connection to a PCB.

14. The phased array antenna of claim 13, wherein the signal member is a first signal member and the phased array antenna further comprises a second signal member attached to the base plate and proximate to the first signal member.

15. The phased array antenna of claim 13, wherein the phased array antenna further comprises a ground member attached to the base plate and proximate to the signal member.

16. The phased array antenna of claim 13, wherein:
a width of the pin of the signal member is no more than 1.5 mm;
an impedance of the signal member is between 45 and 55 ohms; and
the phased array antenna is configured to operate at a frequency of at least 18 GHz.

17. A method of making a phased array antenna, the method comprising:
forming, using at least one additive manufacturing technique, a base plate and a signal member, wherein a pin of the signal member is at least partially disposed within an opening in the base plate; and
forming a plurality of projections around the opening using an electrical discharge machining (EDM) process;
wherein the pin and the plurality of projections extend beyond a bottom plane of the base plate.

18. The method of claim 17, wherein the method further comprises forming, using the at least one additive manufacturing technique, a ground member proximate to the signal member.

19. The method of claim 17, wherein the at least one additive manufacturing technique is at least one of a powder bed fusion process, a micro-stereolithography process, or a material jetting process.

20. The method of claim 17, wherein the EDM process comprises at least one of a wire EDM process or a die-sinking EDM process.
